(19) United States
(12) Patent Application Publication
(10) Pub. No.: US 2018/0022898 A1
(43) Pub. Date: Jan. 25, 2018

(54) FLAME-RETARDANT RESIN COMPOSITION, THERMOSETTING RESIN COMPOSITION, FLAME-RETARDANT ENGINEERING PLASTIC AND COMPOSITE METAL SUBSTRATE

(71) Applicant: GUANGDONG GUANGSHAN NEW MATERIAL CO., LTD., Dongguan (CN)

(72) Inventor: Qingchong Pan, Dongguan (CN)

(21) Appl. No.: 15/640,010

(22) Filed: Jun. 30, 2017

(30) Foreign Application Priority Data
Jul. 21, 2016 (CN) 201610581468.3

(51) Int. Cl. C08K 5/375; C08G 59/24; C08L 67/02; C08G 59/40; C08K 5/21; C08K 5/3492; C08K 5/5357; C08G 59/68

(52) U.S. Cl. CPC C08K 5/375; C08K 5/5357; C08G 59/245; C08G 59/686; C08G 59/4021; C08K 5/21; C08K 5/34922; C08L 67/02; C08L 2201/02

(57) ABSTRACT

The present invention provides a flame-retardant resin composition, a thermosetting resin composition, a flame-retardant engineering plastic and a composite metal substrate. The flame-retardant resin composition comprises a sulfur-containing flame retardant, a phosphorus-containing flame retardant and/or a nitrogen-containing flame retardant, and a halogen-free epoxy resin. The sulfur-containing flame retardant, phosphorus-containing flame retardant and nitrogen-containing flame retardant in the flame-retardant resin composition of the present invention play a synergistic effect, making the prepared copper clad laminate have good flame retardancy, and also good heat resistance, water resistance, adhesion, mechanical properties and electrical properties, and making the prepared engineering plastic have good flame retardancy and good mechanical properties, and thus the flame-retardant resin composition of the present invention is a kind of flame-retardant composition with large economy and friendly environment.

### TECHNICAL FIELD

The present invention belongs to the technical field of flame-retardant materials, in particular relates to a flame-retardant resin composition, a thermosetting resin composition, a flame-retardant engineering plastic and a composite metal substrate.

### BACKGROUND ART

For the purpose of safety, electronic products represented by mobile phones, computers, video cameras and electronic games, household and office electrical products represented by air conditioners, refrigerators, television images, audio products etc., and various products used in other areas require different degrees of flame retardancy.

In order to make the products achieve required flame-retardant performance or grade, traditional techniques often utilize the following means: adding flame-retardant materials such as flame retardants into a material system. However, in order to achieve better flame retardancy, a larger amount of flame retardants may be required. Some flame-retardant materials may produce harmful pollutants, which pollute the environment and affect the health of human and animal, at high temperature or upon burning. Even more, some flame retardants may affect other properties of the materials when the content thereof is high.

Therefore, how to reduce the use amount of flame retardants while ensuring the flame-retardant effect is an urgent problem to be solved in the art.

### Contents of the Invention

In view of this, the purpose of the present invention is to provide a flame-retardant resin composition, a thermosetting resin composition, a flame-retardant engineering plastic composition and a composite metal substrate.

In order to achieve the above purpose, the present invention employs the following technical solution.

In one aspect, the present invention provides a flame-retardant resin composition comprising a sulfur-containing flame retardant, a phosphorus-containing flame retardant and/or a nitrogen-containing flame retardant, and a halogen-free epoxy resin.

Preferably, the weight percentage of the sulfur element in the flame-retardant resin composition is 5% or less, for example 5%, 4.5%, 4%, 3.5%, 3%, 2.5%, 2%, 1.5%, 1%, 0.5%, 0.3%, 0.2%, 0.1%, etc., preferably 0.5-2%.

Preferably, the weight percentage of the phosphorus element in the flame-retardant resin composition is 0.1% or higher, for example 0.1%, 0.15%, 0.2%, 0.25%, 0.3%, 0.4%, 0.5%, 0.6%, 0.7%, 0.8%, 0.9%, 1%, 1.5%, 1.8%, 2%, etc., preferably 0.2-1%.

Preferably, the weight percentage of the nitrogen element in the flame-retardant resin composition is 0.1% or higher, for example 0.1%, 0.15%, 0.2%, 0.25%, 0.3%, 0.4%, 0.5%, 0.6%, 0.7%, 0.8%, 0.9%, 1%, 1.5%, 1.8%, 2%, etc., preferably 0.1-1%.

When the sulfur element, phosphorus element and nitrogen element have contents defined in the present invention respectively, the sulfur-containing flame retardant is coordinated with the phosphorus-containing flame retardant and/or the nitrogen-containing flame retardant and the three flame retardants play a synergistic effect to enhance the flame retardancy of the resin composition. Thus, it is possible to ensure that the resin composition has good flame retardancy, while the contents of sulfur, nitrogen and phosphorus elements can be controlled to be lower ranges. Within these content ranges, various performances of a copper-clad laminate prepared by the flame-retardant resin composition can be optimized, with good heat resistance, water resistance, higher thermal decomposition temperature and others, so that the comprehensive performance of the copper-clad laminate can be improved.

In the present invention, a composite flame retardant is formed by adding a small amount of a phosphorus-containing flame retardant and/or a nitrogen-containing flame retardant on the basis of a sulfur-containing flame retardant and applied in a resin composition, which can make a synergistic flame retardant effect of the sulfur-containing flame retardant with the phosphorus-containing flame retardant and/or the nitrogen-containing flame retardant, while reducing the use amount of flame retardants and saving costs.

In the present invention, the contents of sulfur element and nitrogen element in the flame-retardant resin composition are calculated on the basis that the weight of the flame-retardant resin composition is 100%.

Preferably, the sulfur-containing flame retardant is p-benzenedithiol and/or 4,4′-diaminodiphenyl disulfide, preferably p-benzenedithiol.

Preferably, the phosphorus-containing flame retardant is anyone selected from the group consisting of DOPO etherified bisphenol A, DOPO modified epoxy resin, tris(2,6-dimethylphenyl)phosphine, tetra-(2,6-dimethylphenyl) resorcinol bisphosphate, resorcinol tetraphenyl diphosphate, triphenyl phosphate, bisphenol A bis(diphenyl phosphate), phosphonitrile flame retardant, 10-(2,5-dihydroxyphenyl)-10-hydro-9-oxa-10-phosphaphenanthrene-10-oxide, 10-(2,5-dihydroxynaphthyl)-10-hydro-9-oxa-10-phosphaphenanthrene-10-oxide and 9,10-dihydro-9-oxa-10-phosphaphenanthrene-10-oxide flame retardants, or a mixture of at least two of them.

Preferably, the nitrogen-containing flame retardant is anyone selected from the group consisting of biurea, melamine and melamine phosphate, or a combination of at least two of them.

Other flame-retardant materials may be added to the flame-retardant composition of the present invention as desired.

Preferably, said other flame-retardant material is anyone selected from the group consisting of organosilicone flame retardant, chlorine-containing organic flame retardant and inorganic flame retardant, or a combination of at least two of them.

Preferably, the organosilicone flame retardant is anyone selected from the group consisting of silicone oil, silicone rubber, silane coupling agent, polysiloxane and organosilanolamide, or a combination of at least two of them.

Preferably, the chlorine-containing organic flame retardant is anyone selected from the group consisting of dioctyl tetrachlorophthalate, chlorendic anhydride, chlorendic acid and tetrachlorobisphenol A, or a combination of at least two of them.

Preferably, the inorganic flame retardant is anyone selected from the group consisting of aluminum hydroxide, magnesium hydroxide, antimony trioxide, and zinc borate, or a combination of at least two of them.

Preferably, the halogen-free epoxy resin is anyone selected from the group consisting of bisphenol A epoxy resin, bisphenol F epoxy resin, phenol novolac epoxy resin, bisphenol A novolac epoxy resin, o-cresol novolac epoxy resin, dicyclopentadiene epoxy resin, isocyanate epoxy resin, and biphenyl epoxy resin, or a mixture of at least two of them.

Preferably, the mass percentage of the epoxy resin in the flame-retardant resin composition is 70-95%, for example 70%, 73%, 75%, 78%, 80%, 83%, 85%, 88%, 90%, 92%, 94% or 95%.

In another aspect, the present invention provides a flame-retardant engineering plastic comprising the flame-retardant resin composition as described above.

Preferably, the flame-retardant engineering plastic comprises the following components: 40-60 parts by weight (for example, 43 parts by weight, 45 parts by weight, 48 parts by weight, 50 parts by weight, 53 parts by weight, 55 parts by weight or 58 parts by weight) of a plastic, 5-15 parts by weight (for example, 7 parts by weight, 9 parts by weight, 11 parts by weight or 13 parts by weight) of the flame-retardant resin composition as described above, 0.5-3 parts by weight (for example, 0.6 parts by weight, 0.8 parts by weight, 1 parts by weight, 1.3 parts by weight, 1.5 parts by weight, 1.8 parts by weight, 2 parts by weight, 2.3 parts by weight, 2.5 parts by weight or 2.8 parts by weight) of an auxiliary agent, and 10-20 parts by weight (for example, 12 parts by weight, 14 parts by weight, 16 parts by weight, 18 parts by weight or 19 parts by weight) of a reinforcing filler.

Preferably, the plastic is anyone selected from the group consisting of PC (polycarbonate), ABS (acrylonitrile-butadiene-styrene copolymer), PA (polyamide), PP (polypropylene) and PET (polyethylene terephthalate), or a combination of at least two of them.

Preferably, the auxiliary agent is anyone selected from the group consisting of a lubricant, an antioxidant and a compatibilizer, or a combination of at least two of them.

Preferably, the lubricant is a TAF lubricant.

Preferably, the antioxidant is n-octadecyl-β-(4-hydroxy-3,5-di-tert-butyl-phenyl)propionate and/or organic phosphite powder.

Preferably, the compatibilizer is polysiloxane-acrylate compatibilizer.

Preferably, the reinforcing filler is anyone selected from the group consisting of glass fibers, carbon fibers, metal fibers, whiskers, glass sheets and mineral fillers, or a combination of at least two of them.

In another aspect, the present invention provides a method for preparing the flame-retardant engineering plastic, comprising: mixing raw materials comprising the flame-retardant resin composition of the present invention, and extruding and granulating the mixed raw materials to obtain the flame-retardant engineering plastic.

Preferably, the extrusion and granulation are conducted by using a twin screw extruder at 180-300° C. (for example 190° C., 200° C., 220° C., 240° C., 260° C. or 280° C.).

The sulfur-containing flame retardant, phosphorus-containing flame retardant and/or nitrogen-containing flame retardant in the flame-retardant resin composition of the present invention play a synergistic effect, making the prepared flame-retardant engineering plastic have good flame retardancy and excellent mechanical properties.

In another aspect, the present invention provides a thermosetting resin composition comprising the flame-retardant resin composition as described above.

Preferably, the thermosetting resin composition further comprises a curing agent.

Preferably, the curing agent is anyone selected from the group consisting of dicyandiamide, phenolic resin, aromatic amine, acid anhydride, active ester curing agent and active phenolic curing agent, or a combination of at least two of them.

Preferably, the thermosetting resin composition further comprises a curing accelerator.

Preferably, the curing accelerator is anyone selected from the group consisting of imidazole curing accelerator, organic phosphine curing accelerator, and tertiary amine curing accelerator, or a mixture of at least two of them.

Preferably, the imidazole curing accelerator is anyone selected from the group consisting of 2-methylimidazole, 2-ethyl-4-methylimidazole, 2-phenylimidazole, 2-undecylimidazole, 1-benzyl-2-methylimidazole, 2-heptadecylimidazole, 2-isopropylimidazole, 2-phenyl-4-methylimidazole, 2-dodecylimidazole and 1-cyanoethyl-2-methylimidazole, or a mixture of at least two of them, preferably 2-methylimidazole.

In another aspect, the present invention provides a prepreg which is formed by impregnating a substrate with the above thermosetting resin composition or coating the above thermosetting resin composition onto a substrate.

Preferably, the substrate may be glass fiber substrate, polyester substrate, polyimide substrate, ceramic substrate or carbon fiber substrate, etc.

In the present invention, the specific technological conditions for impregnating or coating are not specifically defined. Said “prepreg” is also the “bonding sheet” well known by those skilled in the art.

A composite metal substrate is prepared by surface-coating a metal layer, overlapping and laminating in sequence at least one sheet of the prepreg above.

Preferably, the material of the metal layer is aluminium, copper, iron and an alloy of any combination thereof.

Preferably, the composite metal substrate is anyone selected from the group consisting of CEM-1 copper clad laminate, CEM-3 copper clad laminate, FR-4 copper clad laminate, FR-5 copper clad laminate, CEM-1 aluminum clad laminate, CEM-3 aluminum clad laminate, FR-4 aluminum clad laminate and FR-5 aluminum clad laminate.

A wiring board is prepared by processing wires on the surface of the composite metal substrate as described above.

Compared with the prior art, the present invention has the following beneficial effects:

The sulfur-containing flame retardant, phosphorus-containing flame retardant and/or nitrogen-containing flame retardant in the flame-retardant resin composition of the present invention play a synergistic effect, making the prepared copper clad laminate have good flame retardancy, and also good heat resistance, water resistance, adhesion, mechanical properties and electrical properties. The copper clad laminate prepared from the flame-retardant resin composition of the present invention has a thermal decomposition temperature (5% weight loss) which can be up to 390° C. or higher, a peeling strength which can be up to 2.4 kg/mm² or higher, T-288 which is more than 100 seconds, a heat resistant limit of tin-dipping which can be 40 times or more, a saturated water absorption which can be 0.22% or less, a flame retardancy (UL-94) which can be Grade V-0. The engineering plastic prepared from the flame-retardant resin composition of the present invention has a flexural strength which can be as high as 82.4-84 MPa, a tensile strength which is up to 65.7-66.2 MPa, a notch impact strength which is up to 26.3-27 J/m, a melt index of 12.2-13.4, an oxygen index of 27.5-28%, and has excellent mechanical properties and good flame retardancy.

### EMBODIMENTS

The technical solutions of the present invention are further explained by combining with the following examples. Those skilled in the art should understand that the following examples are merely illustrations of the present invention and should not be construed as limiting the present invention specifically.

### Example 1

4.9 g of p-benzenedithiol having a sulfur content of 45% and 6.2 g of tetra-(2,6-dimethylphenyl) resorcinol bisphosphate having a phosphorus content of 9.0% were added to 100 g of liquid bisphenol A epoxy resin having an epoxy equivalent of 186 g/eq. After mixing them, a flame-retardant resin composition having a sulfur content of 2% and a phosphorus content of 0.5% was obtained. An appropriate amount of acetone was added to dissolve the composition, and then 5.1 g of dicyandiamide and 0.1 g of 2-methylimidazole were added to make the composition dissolved sufficiently. Then a copper clad laminate was prepared according to a known method. The copper clad laminate was named as copper clad laminate A, and test results of properties thereof are shown in table 1.

### Example 2

3.8 g of p-benzenedithiol having a sulfur content of 45% and 11.5 g of DOPO etherified bisphenol A having a phenolic hydroxyl equivalent of 300.0 g/eq and a phosphorus content of 10.0% were added to 100 g of liquid bisphenol A epoxy resin having an epoxy equivalent of 186 g/eq. After mixing them, a flame-retardant resin composition having a sulfur content of 1.5% and a phosphorus content of 1% was obtained. An appropriate amount of acetone was added to dissolve the composition, and then 46.8 g of linear phenolic resin having a phenolic hydroxyl equivalent of 105 g/eq and 0.1 g of 2-methylimidazole were added to make the composition dissolved sufficiently. Then a copper clad laminate was prepared according to a known method. The copper clad laminate was named as copper clad laminate B, and test results of properties thereof are shown in table 1.

### Example 3

0.9 g of 4,4′-diaminodiphenyl disulfide having a sulfur content of 25.8% and 20.2 g of general DOPO modified epoxy resin having an epoxy equivalent of 300 g/eq were added to 100 g of liquid bisphenol A epoxy resin having an epoxy equivalent of 186 g/eq. After mixing them, a flame-retardant resin composition having a sulfur content of 0.2% and a phosphorus content of 0.5% was obtained. An appropriate amount of acetone was added to dissolve the composition, and then 6.6 g of dicyandiamide and 0.1 g of 2-methylimidazole were added to make the composition dissolved sufficiently. Then a copper clad laminate was prepared according to a known method. The copper clad laminate was named as copper clad laminate C, and test results of properties thereof are shown in table 1.

### Example 4

5.2 g of p-benzenedithiol having a sulfur content of 45% and 11.7 g of DOPO etherified bisphenol A having a phenolic hydroxyl equivalent of 300.0 g/eq and a phosphorus content of 10.0% were added to 100 g of liquid bisphenol A epoxy resin having an epoxy equivalent of 186 g/eq. After mixing them, a flame-retardant resin composition having a sulfur content of 2% and a phosphorus content of 1% was obtained. An appropriate amount of acetone was added to dissolve the composition, and then 44.7 g of linear phenolic resin having a phenolic hydroxyl equivalent of 105 g/eq and 0.1 g of 2-methylimidazole were added to make the composition dissolved sufficiently. Then a copper clad laminate was prepared according to a known method. The copper clad laminate was named as copper clad laminate D, and test results of properties thereof are shown in table 1.

### Example 5

4.7 g of p-benzenedithiol having a sulfur content of 45% and 2.3 g of biurea having a nitrogen content of 47.4% were added to 100 g of liquid bisphenol A epoxy resin having an epoxy equivalent of 186 g/eq. After mixing them, a flame-retardant resin composition having a sulfur content of 2% and a nitrogen content of 1% was obtained. An appropriate amount of acetone was added to dissolve the composition, and then 4.3 g of dicyandiamide and 0.1 g of 2-methylimidazole were added to make the composition dissolved sufficiently. Then a copper clad laminate was prepared according to a known method. The copper clad laminate was named as copper clad laminate E, and test results of properties thereof are shown in table 1.

### Example 6

3.5 g of p-benzenedithiol having a sulfur content of 45% and 3.2 g of melamine having a nitrogen content of 66.7% were added to 100 g of liquid bisphenol A epoxy resin having an epoxy equivalent of 186 g/eq. After mixing them, a flame-retardant resin composition having a sulfur content of 1.5% and a nitrogen content of 2% was obtained. An appropriate amount of acetone was added to dissolve the composition, and then 43.3 g of linear phenolic resin having a phenolic hydroxyl equivalent of 105 g/eq and 0.1 g of 2-methylimidazole were added to make the composition dissolved sufficiently. Then a copper clad laminate was prepared according to a known method. The copper clad laminate was named as copper clad laminate F, and test results of properties thereof are shown in table 1.

### Example 7

0.8 g of 4,4′-diaminodiphenyl disulfide having a sulfur content of 25.8% and 2.3 g of melamine having a nitrogen content of 66.7% were added to 100 g of liquid bisphenol A epoxy resin having an epoxy equivalent of 186 g/eq. After mixing them, a flame-retardant resin composition having a sulfur content of 0.2% and a nitrogen content of 1.5% was obtained. An appropriate amount of acetone was added to dissolve the composition, and then 5.2 g of dicyandiamide and 0.1 g of 2-methylimidazole were added to make the composition dissolved sufficiently. Then a copper clad laminate was prepared according to a known method. The copper clad laminate was named as copper clad laminate G, and test results of properties thereof are shown in table 1.

### Example 8

12.5 g of p-benzenedithiol having a sulfur content of 45% and 0.2 g of biurea having a nitrogen content of 47.4% were added to 100 g of liquid bisphenol A epoxy resin having an epoxy equivalent of 186 g/eq. After mixing them, a flame-retardant resin composition having a sulfur content of 5% and a nitrogen content of 0.1% was obtained. An appropriate amount of acetone was added to dissolve the composition, and then 37.2 g of linear phenolic resin having a phenolic hydroxyl equivalent of 105 g/eq and 0.1 g of 2-methylimidazole were added to make the composition dissolved sufficiently. Then a copper clad laminate was prepared according to a known method. The copper clad laminate was named as copper clad laminate H, and test results of properties thereof are shown in table 1.

### Example 9

5.0 g of p-benzenedithiol having a sulfur content of 45%, 6.3 g of tetra-(2,6-dimethylphenyl) resorcinol bisphosphate having a phosphorus content of 9.0% and 2.4 g of biurea having a nitrogen content of 47.4% were added to 100 g of liquid bisphenol A epoxy resin having an epoxy equivalent of 186 g/eq. After mixing them, a flame-retardant resin composition having a sulfur content of 2%, a phosphorus content of 0.5% and a nitrogen content of 1% was obtained. An appropriate amount of acetone was added to dissolve the composition, and then 4.2 g of dicyandiamide and 0.1 g of 2-methylimidazole were added to make the composition dissolved sufficiently. Then a copper clad laminate was prepared according to a known method. The copper clad laminate was named as copper clad laminate I, and test results of properties thereof are shown in table 1.

### Example 10

4.0 g of p-benzenedithiol having a sulfur content of 45%, 11.8 g of DOPO etherified bisphenol A having a phosphorus content of 10.0% and 3.6 g of melamine having a nitrogen content of 66.7% were added to 100 g of liquid bisphenol A epoxy resin having an epoxy equivalent of 186 g/eq. After mixing them, a flame-retardant resin composition having a sulfur content of 1.5%, a phosphorus content of 1% and a nitrogen content of 2% was obtained. An appropriate amount of acetone was added to dissolve the composition, and then 41.5 g of linear phenolic resin having a phenolic hydroxyl equivalent of 105 g/eq and 0.1 g of 2-methylimidazole were added to make the composition dissolved sufficiently. Then a copper clad laminate was prepared according to a known method. The copper clad laminate was named as copper clad laminate J, and test results of properties thereof are shown in table 2.

### Example 11

1 g of 4,4′-diaminodiphenyl disulfide having a sulfur content of 25.8%, 20.6 g of general DOPO modified epoxy resin having an epoxy equivalent of 300 g/eq and 2.8 g of melamine having a nitrogen content of 66.7% were added to 100 g of liquid bisphenol A epoxy resin having an epoxy equivalent of 186 g/eq. After mixing them, a flame-retardant resin composition having a sulfur content of 0.2%, a phosphorus content of 0.5% and a nitrogen content of 1.5% was obtained. An appropriate amount of acetone was added to dissolve the composition, and then 5.0 g of dicyandiamide and 0.1 g of 2-methylimidazole were added to make the composition dissolved sufficiently. Then a copper clad laminate was prepared according to a known method. The copper clad laminate was named as copper clad laminate K, and test results of properties thereof are shown in table 2.

### Example 12

2.5 g of p-benzenedithiol having a sulfur content of 45%, 11.4 g of DOPO etherified bisphenol A having a phosphorus content of 10.0% and 0.2 g of biurea having a nitrogen content of 47.4% were added to 100 g of liquid bisphenol A epoxy resin having an epoxy equivalent of 186 g/eq. After mixing them, a flame-retardant resin composition having a sulfur content of 1%, a phosphorus content of 1% and a nitrogen content of 0.1% was obtained. An appropriate amount of acetone was added to dissolve the composition, and then 52 g of linear phenolic resin having a phenolic hydroxyl equivalent of 105 g/eq and 0.1 g of 2-methylimidazole were added to make the composition dissolved sufficiently. Then a copper clad laminate was prepared according to a known method. The copper clad laminate was named as copper clad laminate L, and test results of properties thereof are shown in table 2.

### Comparative Example 1

5.9 g of p-benzenedithiol having a sulfur content of 45% was added to 100 g of liquid bisphenol A epoxy resin having an epoxy equivalent of 186 g/eq. After mixing them, a flame-retardant resin composition having a sulfur content of 2.5% was obtained. An appropriate amount of acetone was added to dissolve the composition, and then 5.0 g of dicyandiamide and 0.1 g of 2-methylimidazole were added to make the composition dissolved sufficiently. Then a copper clad laminate was prepared according to a known method. The copper clad laminate was named as copper clad laminate M, and test results of properties thereof are shown in table 2.

### Comparative Example 2

38.5 g of tetra-(2,6-dimethylphenyl) resorcinol bisphosphate having a phosphorus content of 9.0% was added to 100 g of liquid bisphenol A epoxy resin having an epoxy equivalent of 186 g/eq. After mixing them, a flame-retardant resin composition having a phosphorus content of 2.5% was obtained. An appropriate amount of acetone was added to dissolve the composition, and then 5.9 g of dicyandiamide and 0.1 g of 2-methylimidazole were added to make the composition dissolved sufficiently. Then a copper clad laminate was prepared according to a known method. The copper clad laminate was named as copper clad laminate N, and test results of properties thereof are shown in table 2.

### Comparative Example 3

7.1 g of p-benzenedithiol having a sulfur content of 45% was added to 100 g of liquid bisphenol A epoxy resin having an epoxy equivalent of 186 g/eq. After mixing them, a flame-retardant resin composition having a sulfur content of 3% was obtained. An appropriate amount of acetone was added to dissolve the composition, and then 4.8 g of dicyandiamide and 0.1 g of 2-methylimidazole were added to make the composition dissolved sufficiently. Then a copper clad laminate was prepared according to a known method. The copper clad laminate was named as copper clad laminate P, and test results of properties thereof are shown in table 2.

### Comparative Example 4

6.7 g of biurea having a nitrogen content of 47.4% was added to 100 g of liquid bisphenol A epoxy resin having an epoxy equivalent of 186 g/eq. After mixing them, a flame-retardant resin composition having a nitrogen content of 3% was obtained. An appropriate amount of acetone was added to dissolve the composition, and then 3.4 g of dicyandiamide and 0.1 g of 2-methylimidazole were added to make the composition dissolved sufficiently. Then a copper clad laminate was prepared according to a known method. The copper clad laminate was named as copper clad laminate Q, and test results of properties thereof are shown in table 2.

### Comparative Example 5

34.3 g of tetra-(2,6-dimethylphenyl) resorcinol bisphosphate having a phosphorus content of 9.0% and 2.9 g of biurea having a nitrogen content of 47.4% were added to 100 g of liquid bisphenol A epoxy resin having an epoxy equivalent of 186 g/eq. After mixing them, a flame-retardant resin composition having a phosphorus content of 2.5% and a nitrogen content of 1% was obtained. An appropriate amount of acetone was added to dissolve the composition, and then 4.8 g of dicyandiamide and 0.1 g of 2-methylimidazole were added to make the composition dissolved sufficiently. Then a copper clad laminate was prepared according to a known method. The copper clad laminate was named as copper clad laminate R, and test results of properties thereof are shown in table 2.

### Comparative Example 6

6.3 g of tetra-(2,6-dimethylphenyl) resorcinol bisphosphate having a phosphorus content of 9.0% and 7.2 g of biurea having a nitrogen content of 47.4% were added to 100 g of liquid bisphenol A epoxy resin having an epoxy equivalent of 186 g/eq. After mixing them, a flame-retardant resin composition having a phosphorus content of 0.5% and a nitrogen content of 3% was obtained. An appropriate amount of acetone was added to dissolve the composition, and then 3.2 g of dicyandiamide and 0.1 g of 2-methylimidazole were added to make the composition dissolved sufficiently. Then a copper clad laminate was prepared according to a known method. The copper clad laminate was named as copper clad laminate S, and test results of properties thereof are shown in table 2.

TABLE 1

| | | Ex. 1 | Ex. 2 | Ex. 3 | Ex. 4 | Ex. 5 | Ex. 6 | Ex. 7 | Ex. 8 | Ex. 9 |
|---|---|---|---|---|---|---|---|---|---|---|
| | | copper | copper | copper | copper | copper | copper | copper | copper | copper |
| Test | | clad | clad | clad | clad | clad | clad | clad | clad | clad |
| Items | Units | laminate A | laminate B | laminate C | laminate D | laminate E | laminate F | laminate G | laminate H | laminate I |
| Thermal | 5% | 365 | 373 | 369 | 368 | 378 | 375 | 373 | 370 | 403 |
| decomposition | weight | | | | | | | | | |
| temperature | loss/° C. | | | | | | | | | |
| Peeling | kg/cm² | 2.3 | 2.0 | 2.2 | 2.1 | 2.3 | 2.1 | 2.2 | 2.1 | 2.9 |
| strength | | | | | | | | | | |
| T-288 | seconds | >100 | >100 | >100 | >100 | >100 | >100 | >100 | >100 | >100 |
| Heat | times/ | 33 | 36 | 38 | 35 | 44 | 42 | 43 | 40 | 46 |
| resistant | tin-dipping | | | | | | | | | |
| limit | | | | | | | | | | |
| Saturated | wt %/PCT | 0.33 | 0.29 | 0.32 | 0.32 | 0.28 | 0.29 | 0.32 | 0.33 | 0.18 |
| water | | | | | | | | | | |
| absorption | | | | | | | | | | |
| Flame | UL-94 | V-0 | V-0 | V-0 | V-0 | V-0 | V-0 | V-0 | V-0 | V-0 |
| retardancy | | | | | | | | | | |

TABLE 2

| | | | Ex. | | | | | | | |
|---|---|---|---|---|---|---|---|---|---|---|
| | | Ex. | 11 | Ex. | Comp. | Comp. | Comp | Comp. | Comp. | Comp. |
| | | 10 | copper | 12 | Ex. 1 | Ex. 2 | Ex. 3 | Ex. 4 | Ex. 5 | Ex. 6 |
| | | copper | clad | copper | copper | copper | copper | copper | copper | copper |
| | | clad | laminate | clad | clad | clad | clad | clad | clad | clad |
| Test Items | Units | laminate J | K | laminate L | laminate M | laminate N | laminate P | laminate Q | laminate R | laminate S |
| Thermal | 5% | 395 | 390 | 393 | 269 | 272 | 282 | 295 | 271 | 268 |
| decomposition | weight | | | | | | | | | |
| temperature | loss/° C. | | | | | | | | | |
| Peeling | kg/cm² | 2.7 | 2.4 | 2.5 | 1.0 | 1.3 | 1.2 | 1.3 | 1.8 | 1.7 |
| strength | | | | | | | | | | |
| T-288 | seconds | >100 | >100 | >100 | 22 | 25 | 26 | 28 | 65 | 70 |
| Heat resistant | times/ | 44 | 40 | 42 | 7 | 9 | 9 | 10 | 25 | 22 |
| limit | tin- | | | | | | | | | |
| | dipping | | | | | | | | | |
| Saturated | wt %/PCT | 0.19 | 0.22 | 0.2 | 0.45 | 0.41 | 0.45 | 0.41 | 0.42 | 0.40 |
| water | | | | | | | | | | |
| absorption | | | | | | | | | | |
| Flame | UL-94 | V-0 | V-0 | V-0 | complete | complete | complete | complete | combustion | combustion |
| retardancy | | | | | combustion | combustion | combustion | combustion | | |

As can be seen from the test results in Table 1 and Table 2, the copper clad laminates prepared by the flame-retardant resin composition of the present invention have a thermal decomposition temperature (5% weight loss) which can be up to 365° C. or higher, a peeling strength which can be up to 2.0 kg/mm² or higher, T-288 which is more than 100 seconds, a heat resistant limit of tin-dipping which can be 33 times or more, a saturated water absorption which can be 0.33% or less, a flame retardancy (UL-94) which can be Grade V-0.

For a flame-retardant resin composition comprising a sulfur-containing flame retardant and a phosphorus-containing flame retardant, when the phosphorus-containing flame retardant is not used and the amount of the sulfur-containing flame retardant is increased so that the content of sulfur element is equal to the total content of sulfur and phosphorus elements in Example 1 (Comparative Example 1), the prepared copper clad laminate is inferior in flame retardancy and other properties; likewise, when the sulfur-containing flame retardant is not used and the amount of the phosphorus-containing flame retardant is increased so that the content of the phosphorus element is equal to the total content of sulfur and phosphorus elements in Example 1 (Comparative Example 2), the prepared copper clad laminate also has poor performances in flame retardancy and other properties. Therefore, it is illustrated that the sulfur-containing flame retardant and phosphorus-containing flame retardant have a synergistic effect on the flame retardancy in the present invention.

For a flame-retardant resin composition comprising a sulfur-containing flame retardant and a nitrogen-containing flame retardant, when the nitrogen-containing flame retardant is not used and the amount of the sulfur-containing flame retardant is increased so that the content of sulfur element is equal to the total content of sulfur and nitrogen elements in Example 5 (Comparative Example 3), the prepared copper clad laminate is inferior in flame retardancy and other properties; likewise, when the sulfur-containing flame retardant is not used and the amount of the nitrogen-containing flame retardant is increased so that the content of nitrogen element is equal to the total content of sulfur and nitrogen elements in Example 5 (Comparative Example 4), the prepared copper clad laminate also has poor performances in flame retardancy and other properties. Therefore, it is illustrated that the sulfur-containing flame retardant and nitrogen-containing flame retardant have a synergistic effect on the flame retardancy in the present invention.

For a flame-retardant resin composition comprising a sulfur-containing flame retardant, a nitrogen-containing flame retardant and a phosphorus-containing flame retardant, when the sulfur-containing flame retardant is not used and the amount of the phosphorus-containing flame retardant is increased so that the content of phosphorus element is equal to the total content of sulfur element and phosphorus elements in Example 9 (Comparative Example 5), or the amount of the nitrogen-containing flame retardant is increased so that the content of nitrogen element is equal to the total content of nitrogen and sulfur elements in Example 9 (Comparative Example 6), the prepared copper clad laminate has poor performances in flame retardancy and other properties such as heat resistance and water resistance etc. Thus, it is illustrated that the sulfur-containing flame retardant, the phosphorus-containing flame retardant play a synergistic effect with the nitrogen-containing flame retardant, making the prepared copper clad laminate have good flame retardancy, and also good heat resistance, water resistance, adhesion, mechanical properties and electrical properties.

Therefore, the sulfur-containing flame retardant of the present invention play a synergistic effect with the phosphorus-containing flame retardant and/or the nitrogen-containing flame retardant, enhancing the flame retardancy of the resin composition and making the prepared copper clad laminate have good flame retardancy, and also good heat resistance, water resistance, adhesion, mechanical properties and electrical properties.

### Example 13

4.9 g of p-benzenedithiol having a sulfur content of 45% and 6.2 g of tetra-(2,6-dimethylphenyl) resorcinol bisphosphate having a phosphorus content of 9.0% were added to 100 g of liquid bisphenol A epoxy resin having an epoxy equivalent of 186 g/eq. After mixing them, a flame-retardant resin composition having a sulfur content of 2% and a phosphorus content of 0.5% was obtained.

50 parts by weight of PC, 10 parts by weight of the flame-retardant resin composition obtained as described above, 1 parts by weight of a lubricant, 0.8 parts by weight of an antioxidant, 0.7 parts by weight of a compatibilizer and 20 parts by weight of glass fiber were thoroughly mixed using a mixer. Then, the mixture was extruded and granulated using a twin screw extruder at 200° C. to obtain an engineering plastic A, and test results of properties thereof are shown in table 3.

### Example 14

4.7 g of p-benzenedithiol having a sulfur content of 45% and 2.3 g of of biurea having a nitrogen content of 47.4% were added to 100 g of liquid bisphenol A epoxy resin having an epoxy equivalent of 186 g/eq. After mixing them, a flame-retardant resin composition having a sulfur content of 2% and a nitrogen content of 1% was obtained.

40 parts by weight of ABS, 5 parts by weight of the flame-retardant resin composition obtained as described above, 1.2 parts by weight of a lubricant, 0.5 parts by weight of an antioxidant, 0.9 parts by weight of a compatibilizer and 15 parts by weight of carbon fiber were thoroughly mixed using a mixer. Then, the mixture was extruded and granulated using a twin screw extruder at 180° C. to obtain an engineering plastic B, and test results of properties thereof are shown in table 3.

### Example 15

5.0 g of p-benzenedithiol having a sulfur content of 45%, 6.3 g of tetra-(2,6-dimethylphenyl) resorcinol bisphosphate having a phosphorus content of 9.0%, and 2.4 g of biurea having a nitrogen content of 47.4% were added to 100 g of liquid bisphenol A epoxy resin having an epoxy equivalent of 186 g/eq. After mixing them, a flame-retardant resin composition having a sulfur content of 2%, a phosphorus content of 0.5% and a nitrogen content of 1% was obtained.

60 parts by weight of PET, 15 parts by weight of the flame-retardant resin composition obtained as described above, 1 parts by weight of a lubricant, 0.9 parts by weight of an antioxidant, 1.1 parts by weight of a compatibilizer and 10 parts by weight of glass fiber were thoroughly mixed using a mixer. Then, the mixture was extruded and granulated using a twin screw extruder at 300° C. to obtain an engineering plastic C, and test results of properties thereof are shown in table 3.

### Comparative Example 7

An engineering plastic D was prepared using the same engineering plastic raw materials and amounts thereof and the same method as Example 13, except that: 5.9 g of p-benzenedithiol having a sulfur content of 45% was added to 100 g of liquid bisphenol A epoxy resin having an epoxy equivalent of 186 g/eq, and after mixing them, a flame-retardant resin composition having a sulfur content of 2.5% was obtained. Test results of properties of the engineering plastic D are shown in table 3.

### Comparative Example 8

An engineering plastic E was prepared using the same engineering plastic raw materials and amounts thereof and the same method as Example 13, except that: 38.5 g of tetra-(2,6-dimethylphenyl) resorcinol bisphosphate having a phosphorus content of 9.0% was added to 100 g of liquid bisphenol A epoxy resin having an epoxy equivalent of 186 g/eq, and after mixing them, a flame-retardant resin composition having a phosphorus content of 2.5% was obtained. Test results of properties of the engineering plastic E are shown in table 3.

### Comparative Example 9

An engineering plastic F was prepared using the same engineering plastic raw materials and amounts thereof and the same method as Example 14, except that: 7.1 g of p-benzenedithiol having a sulfur content of 45% was added to 100 g of liquid bisphenol A epoxy resin having an epoxy equivalent of 186 g/eq, and after mixing them, a flame-retardant resin composition having a sulfur content of 3% was obtained. Test results of properties of the engineering plastic F are shown in table 3.

### Comparative Example 10

An engineering plastic G was prepared using the same engineering plastic raw materials and amounts thereof and the same method as Example 14, except that: 6.7 g of biurea having a nitrogen content of 47.4% was added to 100 g of liquid bisphenol A epoxy resin having an epoxy equivalent of 186 g/eq, and after mixing them, a flame-retardant resin composition having a nitrogen content of 3% was obtained. Test results of properties of the engineering plastic G are shown in table 3.

### Comparative Example 11

An engineering plastic H was prepared using the same engineering plastic raw materials and amounts thereof and the same method as Example 15, except that: 34.3 g of tetra-(2,6-dimethylphenyl) resorcinol bisphosphate having a phosphorus content of 9.0% and 2.9 g of biurea having a nitrogen content of 47.4% were added to 100 g of liquid bisphenol A epoxy resin having an epoxy equivalent of 186 g/eq, and after mixing them, a flame-retardant resin composition having a phosphorus content of 2.5% and a nitrogen content of 1% was obtained. Test results of properties of the engineering plastic H are shown in table 3.

### Comparative Example 12

An engineering plastic I was prepared using the same engineering plastic raw materials and amounts thereof and the same method as Example 15, except that: 6.3 g of tetra-(2,6-dimethylphenyl) resorcinol bisphosphate having a phosphorus content of 9.0% and 7.2 g of biurea having a nitrogen content of 47.4% were added to 100 g of liquid bisphenol A epoxy resin having an epoxy equivalent of 186 g/eq, and after mixing them, a flame-retardant resin composition having a phosphorus content of 0.5% and a nitrogen content of 3% was obtained. Test results of properties of the engineering plastic I are shown in table 3.

TABLE 3

| | | | | | | | Comp. | | |
|---|---|---|---|---|---|---|---|---|---|
| | Ex. | Ex. | Ex. | Comp. | Comp. | Comp. | Ex. | Comp. | Comp. |
| Test Items | 13 | 14 | 15 | Ex. 7 | Ex. 8 | Ex. 9 | 10 | Ex. 11 | Ex. 12 |
| Bending | 82.6 | 82.4 | 84.0 | 80 | 81 | 80.5 | 81.2 | 79.3 | 79.6 |
| strength | | | | | | | | | |
| (MPa) | | | | | | | | | |
| Tensile | 65.9 | 65.7 | 66.2 | 61.9 | 62 | 63 | 63.1 | 62.4 | 64 |
| strength | | | | | | | | | |
| (MPa) | | | | | | | | | |
| Notch | 26.6 | 26.3 | 27 | 20.8 | 21.1 | 20.8 | 21.1 | 22 | 20.7 |
| impact | | | | | | | | | |
| strength | | | | | | | | | |
| (J/m) | | | | | | | | | |
| Melt index | 12.2 | 12.6 | 13.4 | 16.1 | 15.9 | 15.6 | 15.7 | 15.1 | 15.6 |
| (280° C., | | | | | | | | | |
| 2.16 KG) | | | | | | | | | |
| Oxygen | 27.5 | 28 | 27.9 | 22.3 | 22 | 21 | 23 | 24.2 | 24.1 |
| index (%, | | | | | | | | | |
| GB/T | | | | | | | | | |
| 2406-2009) | | | | | | | | | |

As can be seen from the comparison of the test results of Examples 13-15 and Comparative Examples 7-12 in Table 3, the engineering plastics prepared by the present invention have good flame retardancy due to a synergistic effect of a sulfur-containing flame retardant, a phosphorus-containing flame retardant and/or a nitrogen-containing flame retardant, and good mechanical properties due to the cooperation of various raw materials of the engineering plastic.

The applicant states that: the present invention illustrates the flame-retardant resin composition, the thermosetting resin composition, the prepreg and the composite metal substrate of the present invention by the above examples, but the present invention is not limited to the above examples, that is to say, it does not mean that the present invention must be conducted relying on the above examples. Those skilled in the art should understand that any modification to the present invention, any equivalent replacement of each raw material of the products of the present invention and the addition of auxiliary ingredients, the selection of specific embodiment and the like all fall into the protection scope and the disclosure scope of the present invention.

1. A flame-retardant resin composition, characterized in that the flame-retardant resin composition comprises a sulfur-containing flame retardant, a phosphorus-containing flame retardant and/or a nitrogen-containing flame retardant, and a halogen-free epoxy resin.

2. The flame-retardant resin composition of claim 1, characterized in that the weight percentage of the sulfur element in the flame-retardant resin composition is 5% or less.

3. The flame-retardant resin composition of claim 1, characterized in that the weight percentage of the phosphorus element in the flame-retardant resin composition is 0.1% or higher.

4. The flame-retardant resin composition of claim 1, characterized in that the weight percentage of the nitrogen element in the flame-retardant resin composition is 0.1% or higher.

5. The flame-retardant resin composition of claim 1, characterized in that the sulfur-containing flame retardant is p-benzenedithiol and/or 4,4′-diaminodiphenyl disulfide.

6. The flame-retardant resin composition of claim 1, characterized in that the phosphorus-containing flame retardant is anyone selected from the group consisting of DOPO etherified bisphenol A, DOPO modified epoxy resin, tris(2,6-dimethylphenyl)phosphine, tetra-(2,6-dimethylphenyl) resorcinol bisphosphate, resorcinol tetraphenyl diphosphate, triphenyl phosphate, bisphenol A bis(diphenyl phosphate), phosphonitrile flame retardant, 10-(2,5-dihydroxyphenyl)-10-hydro-9-oxa-10-phosphaphenanthrene-10-oxide, 10-(2,5-dihydroxynaphthyl)-10-hydro-9-oxa-10-phosphaphenanthrene-10-oxide and 9,10-dihydro-9-oxa-10-phosphaphenanthrene-10-oxide flame retardants, or a mixture of at least two of them.

7. The flame-retardant resin composition of claim 1, characterized in that the nitrogen-containing flame retardant is anyone selected from the group consisting of biurea, melamine and melamine phosphate, or a combination of at least two of them.

8. The flame-retardant resin composition of claim 1, characterized in that the flame-retardant resin composition further comprises other flame-retardant materials.

9. The flame-retardant resin composition of claim 8, characterized in that the other flame-retardant material is anyone selected from the group consisting of organosilicone flame retardant, chlorine-containing organic flame retardant and inorganic flame retardant, or a combination of at least two of them.

10. The flame-retardant resin composition of claim 9, characterized in that the organosilicone flame retardant is anyone selected from the group consisting of silicone oil, silicone rubber, silane coupling agent, polysiloxane and organosilanolamide, or a combination of at least two of them.

11. The flame-retardant resin composition of claim 9, characterized in that the chlorine-containing organic flame retardant is anyone selected from the group consisting of dioctyl tetrachlorophthalate, chlorendic anhydride, chlorendic acid and tetrachlorobisphenol A, or a combination of at least two of them.

12. The flame-retardant resin composition of claim 9, characterized in that the inorganic flame retardant is anyone selected from the group consisting of aluminum hydroxide, magnesium hydroxide, antimony trioxide, and zinc borate, or a combination of at least two of them.

13. The flame-retardant resin composition of claim 1, characterized in that the halogen-free epoxy resin is anyone selected from the group consisting of bisphenol A epoxy resin, bisphenol F epoxy resin, phenol novolac epoxy resin, bisphenol A novolac epoxy resin, o-cresol novolac epoxy resin, dicyclopentadiene epoxy resin, isocyanate epoxy resin, and biphenyl epoxy resin, or a mixture of at least two of them.

14. The flame-retardant resin composition of claim 1, characterized in that the mass percentage of the halogen-free epoxy resin in the flame-retardant resin composition is 70-95%.

15. A flame-retardant engineering plastic, characterized in that the flame-retardant engineering plastic comprises the flame-retardant resin composition of claim 1.

16. The flame-retardant engineering plastic of claim 15, characterized in that the flame-retardant engineering plastic comprises the following components in parts by weight: 40-60 parts by weight of a plastic, 5-15 parts by weight of the flame-retardant resin composition of anyone of claims 1-4, 0.5-3 parts by weight of an auxiliary agent and 10-20 parts by weight of a reinforcing filler.

17. The flame-retardant engineering plastic of claim 16, characterized in that the plastic is anyone selected from the group consisting of PC, ABS, PA, PP and PET, or a combination of at least two of them.

18. The flame-retardant engineering plastic of claim 16, characterized in that the auxiliary agent is anyone selected from the group consisting of a lubricant, an antioxidant and a compatibilizer, or a combination of at least two of them.

19. A thermosetting resin composition, characterized in that the thermosetting resin composition comprises the flame-retardant resin composition of claim 1.

20. The thermosetting resin composition of claim 19, characterized in that the thermosetting resin composition further comprises a curing agent;
the curing agent is anyone selected from the group consisting of dicyandiamide, phenolic resin, aromatic amine, acid anhydride, active ester curing agent and active phenolic curing agent, or a combination of at least two of them.

21. The thermosetting resin composition of claim 19, characterized in that the thermosetting resin composition further comprises a curing accelerator;
the curing accelerator is anyone selected from the group consisting of imidazole curing accelerator, organic phosphine curing accelerator, and tertiary amine curing accelerator, or a mixture of at least two of them.
